(19) United States
(12) Patent Application Publication
(10) Pub. No.: US 2017/0210611 A1
(43) Pub. Date: Jul. 27, 2017

(54) INTERCHANGEABLE BUTTON SYSTEM FOR UPHOLSTERED FURNITURE

(71) Applicant: Buttons With Benefits, LLC, Austin, TX (US)

(72) Inventors: Sheri Lynn Bingham, Austin, TX (US); Christian Robert Bingham, Austin, TX (US)

(21) Appl. No.: 15/411,024

(22) Filed: Jan. 20, 2017

Related U.S. Application Data
(60) Provisional application No. 62/281,996, filed on Jan. 22, 2016.

(51) Int. Cl. B68G 13/02; A44B 1/04; A44B 1/24; F16B 1/00; A44B 17/00; A44B 1/14

(52) U.S. Cl. CPC B68G 13/02; A44B 17/0023; A44B 1/14; A44B 1/24; F16B 1/00; A44B 1/04; F16B 2001/0035; F16B 2001/0028

(57) ABSTRACT

An interchangeable button system along with methods for its use and manufacture are disclosed. An interchangeable button system according to embodiments includes a base and a button. The base may comprise an attachment point for attaching the base to a piece of furniture and a fastener opposite the attachment point. The button may comprise a button base and a fastener. The base may be attached to a piece of furniture using the attachment point and a button may be removeably coupled to the base using the fasteners such that different buttons may be interchangeably coupled to the same affixed base. These different buttons may, for example, have buttons that are of different shapes or sizes, are covered with different upholstery, made from a material that may be left uncovered or that may differ from one another in some other type of aesthetic or functional manner.

### RELATED APPLICATIONS

This application claims priority under 35 U.S.C. §119 to U.S. Provisional Patent Application No. 62/281,996, filed Jan. 22, 2016, entitled “Interchangeable Button System For Upholstered Furniture” by Sheri Lynn Bingham and Christian Robert Bingham. All applications referenced herein are hereby fully incorporated by reference for all purposes.

### TECHNICAL FIELD

This disclosure relates generally to upholstered furniture. In particular, this disclosure relates to hardware for use in upholstering furniture. More specifically, this disclosure relates to an interchangeable button system for upholstered furniture. Even more specifically, this disclosure relates to an interchangeable button system for use with tufted upholstery.

### BACKGROUND

Currently, furniture often comprises buttons which are permanently attached to the furniture. Such buttons are often used, for example, in upholstering tufted furniture. These buttons are typically one piece having a loop formed in, or permanently affixed to, the underside of a cap that is covered in fabric or other upholstering material. The process of attaching a button to furniture when upholstering the furniture (e.g., when tufting a piece of furniture) involves passing a tufting needle and thread completely through the furniture. The thread is then passed through the loop on the underside of the button. The thread is then inserted into the needle and the needle is again passed through the furniture. The thread is pulled until the appropriate or desired tension is achieved and the thread is tied off on the underside of the furniture. For aesthetic reasons, the tied ends are often enclosed within the furniture. Once tied then, the button is permanently attached to the furniture, it cannot be removed or replaced without repeating the attaching process.

In many cases, however, it may be necessary to replace a button after the furniture is assembled, such as if the button has become damaged or the owner wishes to change the button for aesthetic reasons. In replacing the button using traditional methods, the thread on the existing button would be cut and a new button would be attached in the same manner as described above. Often, this requires disassembly of the furniture to gain access to tie the thread on the new button. Button replacement is therefore labor intensive and may be above the skill level of the average person.

It would therefore be desirable to have a button system that remedies at least some the problems of current buttons used with upholstered furniture.

### SUMMARY

To address those desires, among other ends, embodiments as disclosed herein may provide an interchangeable button system. Embodiments of this button system may be used on almost any upholstered item desired, including furniture, pillows, vehicle seats, marine applications or the like (hereinafter referred to as simply furniture). An interchangeable button system according to embodiments includes a base portion (referred to hereinafter as the base) and a button portion (referred to hereinafter as the button). The base may comprise an attachment point such as a loop for attaching the base to a piece of furniture and a first fastener opposite the attachment point. The button may comprise a button base and a second fastener. The first fastener may be configured to attach to the second fastener. These first and second fastener may be, for example,: a snap, a magnetic fastener, a threaded fastener, or a hook and loop fastener.

According to embodiments then, the base may be attached to a piece of furniture using the attachment point (e.g., using thread through the attachment point and tied off on the underside of the furniture) and a button may be removeably coupled to the base using their respective fasteners such that different buttons may be interchangeably coupled to the same affixed base. These different buttons may, for example, have buttons that are of different shapes or sizes, are covered with different upholstery, made from a material that may be left uncovered (e.g., polished wood), or that may differ from one another in some other type of aesthetic or functional manner.

In one embodiment, the button base may include a button cap and a button cap base. The second fastener is coupled to the button cap base. The button cap base and button cap are shaped or otherwise configured to be coupled to one another. In this manner, different button caps may be utilized with the same button cap base, further facilitating the interchangeability of embodiments. Moreover, by utilizing a button cap base that can accommodate a button cap of a type typically used in upholstering furniture (e.g., of a certain size such as a #33, #45 or #60 button size or of a typical shape used for such button caps) button caps manufactured or upholstered by another entity may be easily utilized with embodiments of an interchangeable button system as disclosed herein.

In certain embodiments, the button base may include a disk portion. The disk portion may be made out of any suitable material, such as metal or polymer. The disk portion may be disposed between the second fastener and the loop of the button base. The disk portion may be of a diameter selected to distribute at least a portion of the force applied to the loop of the base to the surrounding upholstery when the base is affixed to a piece of furniture.

The use of a disk portion in embodiments may be particularly useful when the interchangeable button system is utilized in tufted upholstery as a certain amount of force is required to be applied to the upholstery to create or maintain the tuft in the upholstery. The use of a disk portion in such applications may distribute at least a portion of the force applied to the loop of the base to the surrounding upholstery when the base is affixed to a piece of furniture. Thus, the force required to, for example, create or maintain the tuft can be applied to the upholstery of the furniture through the disk of the base (e.g., not the button portion). Additionally, the disk portion may serve to increase or maintain the distance between the walls of the tuft at the bottom of the tuft such that the walls of the tuft do not apply a removing force (e.g., a force sufficient to separate the respective fasteners of the base and the button) to the button of the interchangeable button system when the button is coupled to the base, even in cases where the tuft shifts or the walls of the tuft change shape or displace (e.g., when someone sits on the furniture).

Accordingly, embodiments as disclosed herein may provide a number of advantages. Importantly, embodiments allow the buttons to be quickly and easily interchanged by unskilled persons, such as when it is desired to replace a damaged button or change the look or feel of a piece of furniture by replacing the buttons with differently upholstered buttons. Interchangeable buttons may be useful, for example, to change furniture based on customer preference, such as during redecoration of a room or if a piece of furniture is moved to a room decorated differently than the previous room. Interchangeable buttons also allow an owner to change button or the season or have buttons specific to various holidays. Interchangeable buttons may also be useful if a piece of furniture changes ownership. Buttons could also be replaced to customize furniture for a business, such as by putting a logo on the buttons or for furniture rental where buttons may be replaced for a specific event. Additionally, all of the buttons on a piece of furniture need not be identical. A single piece of furniture may utilize buttons of various colors, patterns, materials, sizes, etc. Various buttons could, for example, be used to make a pattern such as a sports team's colors, a country's flag, or even to spell out words on a piece of furniture.

Interchangeable buttons may also reduce damage to furniture or the cost involved in repairing furniture. For example, using embodiments of an interchangeable button system as presented herein, if a button gets caught, such as on a piece of clothing, the button may release from the base without damaging the thread holding the base to the furniture, the upholstery or another part of the furniture such as the decking. Additionally, interchangeable buttons may facilitate the installation or replacement of a slipcover on a piece of furniture. For example, one or more bases may be attached to a furniture form. A slipcover or other upholstery with corresponding button holes (that may be of a size just large enough to pass the base through) may be used to cover the furniture form. The bases can then be pushed through the holes in the slipcover and the slipcover adjusted as needed. A corresponding button can be installed on each of the bases as desired. When buttons are installed on the bases, the buttons may obscure the openings in the slipcover. Similarly, when replacing a slipcover, the buttons on the piece of furniture may be removed from their respective bases without removing the bases from the furniture and a replacement slipcover installed as described.

Interchangeable buttons may also allow for fast customization by the customer or manufacturer. Additionally, a manufacturer or retailer may reduce inventory, storage, and lead-time requirements by stocking a quantity of furniture without buttons. Upon receiving an order, the appropriate buttons may be attached or simply included with the furniture.

These and other aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

For a better understanding of these and other objects of the invention, reference will be made to the following detailed description which is to be read in association with the accompanying drawings. The drawings accompanying and forming part of this specification are included to depict certain aspects of particular embodiments. A clearer impression of embodiments, and of the components and operation of systems provided with particular embodiments, will become more readily apparent by referring to the exemplary, and therefore non-limiting, embodiments illustrated in the drawings, wherein identical reference numerals designate the same components. Note that the features illustrated in the drawings are not necessarily drawn to scale.

FIGS. 1A and 1B are side views of embodiments of an interchangeable button system.

FIG. 2A is a view of one embodiment of an interchangeable button system utilizing a size #45 button cap.

FIG. 2B is a view of one embodiment of an interchangeable button system utilizing a size #60 button cap.

FIG. 3A is a view of one embodiment of a base of an interchangeable button system.

FIG. 3B is a view of one embodiment of an interchangeable button system utilizing a size #60 button cap.

FIG. 3C is a view of one embodiment of an interchangeable button system utilizing a size #45 button cap.

FIG. 4 is a depiction of an interchangeable button system attached to furniture.

FIGS. 5A-5C illustrate one embodiment of an interchangeable button system attached to a piece of furniture.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As discussed above, furniture, especially furniture with tufted upholstery, often uses buttons which are permanently attached to the furniture. In the case of tufted upholstery buttons may be used to create and maintain the tuft by applying the required tension to the upholstery. These buttons are typically one piece including a cap that is covered in an upholstering material and a loop on the underside of the cap. The button is attached to the furniture by passing a thread through the loop and the furniture. The thread is pulled until the appropriate or desired tension is achieved (e.g., a desired depth or radius of a tuft created by the button) and the thread is tied off on the underside of the furniture. The button is thus permanently attached to the furniture, it cannot be removed and replaced without repeating the attaching process.

In many cases, however, for aesthetic or functional reasons it may be desired to replace such a button. Because of the construction of one-piece buttons and how such buttons are attached to furniture, replacement of these permanently attached buttons may be labor intensive, require disassembly of the furniture (e.g., to access the thread used to attach the button), or require greater skill than possessed by an average individual.

It is thus desirable to ameliorate problems inherent in the use of such permanently attached or one-piece buttons. To those ends, among others, embodiments as disclosed herein provide an interchangeable button system. An interchangeable button system according to embodiments includes a base portion (referred to as the base) and a button portion (referred to as the button). The base may comprise a loop for attaching the base to a piece of furniture and a first fastener opposite the loop. The button may comprise a button base and a second fastener. The first fastener may be configured to attach to the second fastener.

According to embodiments then, the base may be attached to a piece of furniture using the loop (e.g., substantially permanently using thread through the loop and tied off on the underside of the furniture) and a button may be removeably coupled to the attached base using their respective fasteners such that different buttons may be interchangeably coupled to the same affixed base. The base and the button, including the respective fasteners, are thus configured to attach the button to the base such that the button is held to the base during normal use of the furniture but can easily be removed and changed if desired. These different buttons may, for example, have buttons that are of different shapes or sizes, are covered with different upholstery, or that may differ from one another in some other type of aesthetic or functional manner.

The button base may include a disk portion disposed between the second fastener and the loop of the button base. The disk portion may be of a diameter selected to distribute at least a portion of the force applied to the loop of the base to the surrounding upholstery when the base is affixed to a piece of furniture. The use of a disk portion in embodiments may be particularly useful when the interchangeable button system is utilized in tufted upholstery as a certain amount of force is required to be applied to create or maintain the tuft in the upholstery. When the base is attached to the furniture the force required to create or maintain the tuft can be applied to the upholstery of the furniture through the disk of the base (e.g., not the button portion). The diameter of the disk utilized for a given embodiment may also be selected based on the size of the button it is desired to utilize.

Accordingly, the use of disk portion may serve to prevent force from being applied to the button portion, including any force required to maintain or create a tuft. Similarly, then, the use of disk to create or maintain the tuft may serve to maintain or increase a distance between the walls of the tuft at the bottom of the tuft such that the walls of the tuft do not apply removing force to the button portion of the interchangeable button system when the button portion is coupled to the base, even in cases where the tuft shifts or the walls of the tuft change shape or displace (e.g., when someone sits on the furniture). Moreover, the use of a disk portion in such applications may prevent the fastener of the base portion from pulling through any opening in the fabric through which the loop of the base, or the thread used to affix the base to the furniture, passes.

Interchangeable button systems as disclosed may therefore be useful, for example, to easily change furniture based on need or preference, including for example, for repair or decoration and may provide a variety of aesthetic options, as the button of such systems may be of different or varies, size, shape, color, material, etc. To achieve such advantages, the base of each interchangeable button system only needs to be attached to the furniture a single time. Subsequently almost any type of button desired may be interchangeably attached to the affixed base by unskilled persons without the need to re-install the base.

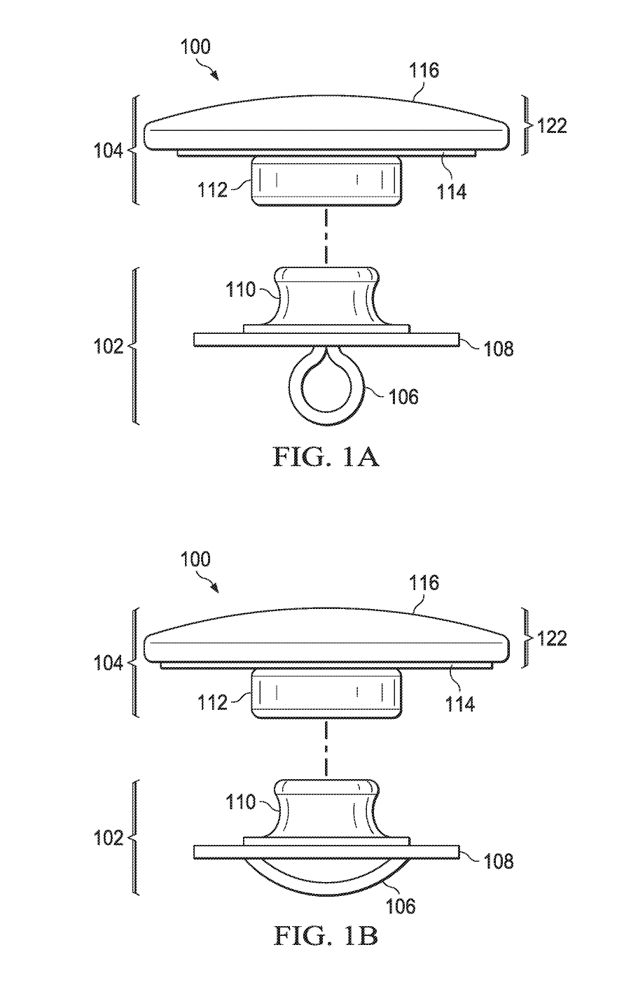

Turning now to FIGS. 1A and 1B, a side view of embodiments of an interchangeable button system in accordance with embodiments is shown. Interchangeable button system 100 may be comprised of base 102 and button 104. Base 102 may be comprised of disk portion 108 (also known as the disk), base fastener 110, and attachment point 106. Button 104 may be comprised of button base 122 and button fastener 112. While the button base 122 may be a single unit, in one embodiment the button base 122 includes button cap base 114 and button cap 116. The button cap 116 may be covered with a desired upholstery fabric or otherwise made of a desired material. Base fastener 110 and button fastener 112 are configured to removeably fasten button 104 onto base 102. The fasteners 110, 112 may be selected to provide sufficient strength to maintain the fastening of button 104 to base 102 under normal use of furniture. For example, base fastener 110 may be a male snap fastener and button fastener 112 may be a corresponding female snap fastener. Other types of fasteners such as a magnetic fastener, a threaded fastener, or a hook and loop fastener may be utilized and are fully contemplated herein.

Base 102 may be comprised of one or more pieces, for example, base 102 may be formed from a single piece or may be multiple pieces which are then assembled. In one embodiment, base 102 may comprise disk 108, base fastener 110 coupled to the disk 108, and attachment point 106 coupled to the base fastener 110 or the disk 108 and disposed on the opposite side of the disk 108 from base fastener 110. The attachment point 106 may be attached to, or formed from, disk 108 and may be used for attaching the base 102 to furniture. In one embodiment, attachment point 106 may comprise a loop for passing a thread or other affixing mechanism through. Attachment point 106 may also be any other suitable means such as a hook, threaded fastener or the like.

Disk 108 may be made of any suitable material, including wood, metal or polymer. The shape or material of disk 108 may be chosen or made to reduce abrasion on the upholstery of the furniture or the thread used to attach the base 102 to the furniture. For example, disk 108 may have rounded or chamfered edges or may be tumbled or polished with a media such as walnut shells, sand or other abrasive material to achieved a desired texture or level of smoothness. In one embodiment, the disk 108 may be made of a metal such as stainless steel or a high density low friction (HDLF) polymer.

When base 102 is attached to a piece of furniture (e.g., when creating a tuft in the furniture using the base 102), disk 108 may contact the upholstery of the furniture. The force necessary to create or maintain a tuft can thus be applied to the upholstery of the furniture through the disk 108. The disk 108 may additionally prevent base 102 from pulling through the created tuft.

The thickness and diameter of the disk 108 may be chosen such that when the button 104 is attached to the base 102, the button cap 116 is at a desired height. The desired height may be based on functional or aesthetic concerns. For example, if the base 102 sits too low, the button 104 may be difficult to attach to the base 102 or the button 104 may release during normal use. If the base 102 sits too high, the button 104 may be easily snagged on clothing or appear to hover above the furniture, leaving the base 102 visible underneath. The thickness of the disk 108 may also be chosen to provide sufficient rigidity to allow a desired amount of tension to be placed on the thread used to attach the base to the furniture (e.g., to create or maintain a tuft).

In one embodiment, the disk 108 may be a circular disk. In embodiments where the base fastener 110 is directly coupled to the attachment point 106, or the base fastener and the attachment point 106 are a single piece of material, the disk 108 may be annular (e.g., a washer or the like) such that one end of the attachment point 106 or fastener 110 (or the single piece comprising the attachment point and fastener) may pass through the annular region of the disk 108 to couple to one another. In other embodiments, the attachment point 106 may be formed from part of the disk 108, such as by creating a half-shear in the material of the disk and punching or extruding a portion of the material of the disk 108 to form the attachment point 106. Other disk shapes may also be used, such as, for example, triangular, rectangular, hexagonal, etc. or the disk may be shaped to fit the furniture tuft.

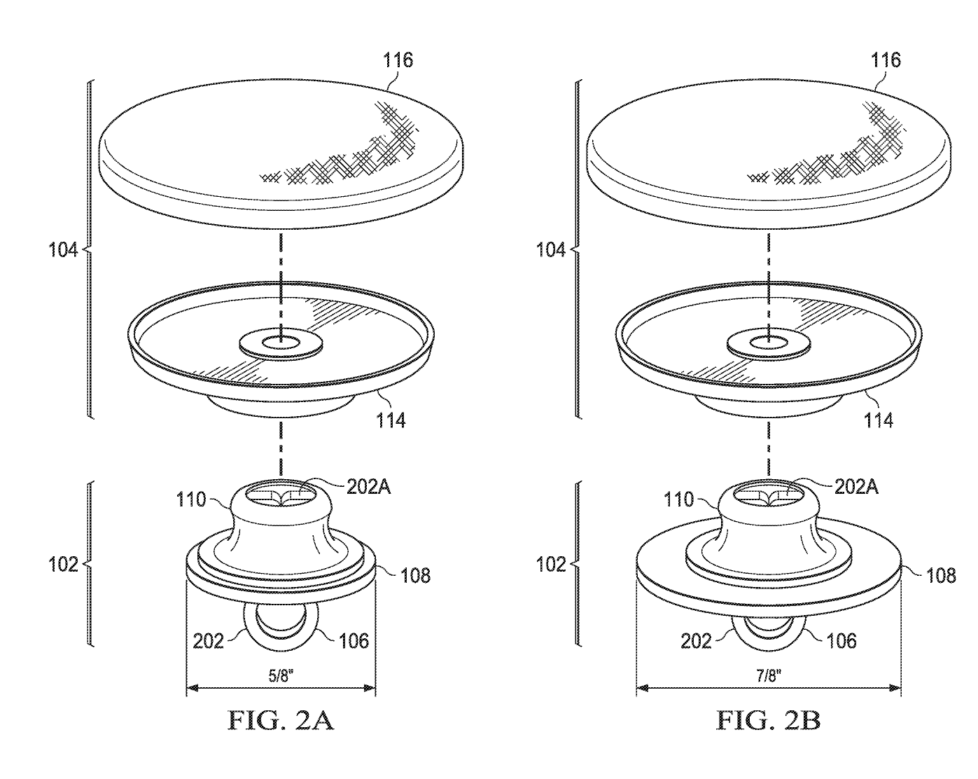

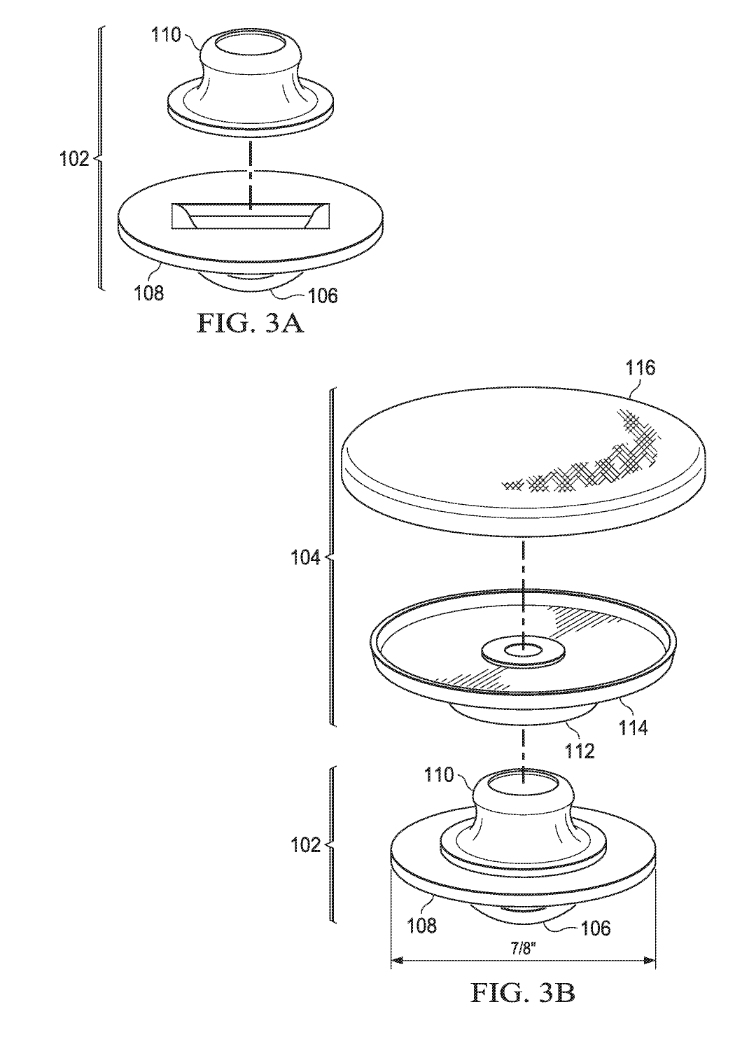

Referring to FIGS. 2A and 2B, in one embodiment, as illustrated in FIG. 2A, disk 108 may have a diameter of approximately ⅝″ and a thickness of ⅛″ when used with a size #45 button 104. Other embodiments for use with a size #45 button may have a disk 108 of approximately 9/16″ diameter. Attachment point 106 may be a loop having a diameter of approximately 3/16″. Button 104 includes a button cap 116 and button cap base 114 coupled to fastener 112. Fastener 112 may be coupled to the button cap base 114 by spot or tack welding, by adhesive or by another coupling mechanism. The button cap base 114 may be configured to be coupled to button cap 116. Button cap 116 may of a shape that is standard in the industry such that different button caps 116 (e.g., covered with different upholstery, or made of a different material) may be utilized with the same button cap base 114, further facilitating the interchangeability of embodiments. Moreover, by utilizing a button cap base 114 that can accommodate a button cap 116 of a type typically used in upholstering furniture button caps 116 manufactured or upholstered by another entity may be easily utilized with embodiments of the interchangeable button system. Similarly, In another embodiment, as illustrated in FIG. 2B, disk 108 may have a diameter of ⅞″ and a thickness of ⅛″ when used with a size 60 button.

In one embodiment base 102 may include an annular disk 108 or a disk 108 that otherwise has a hole therethrough. The hole may be located in the center of disk 108. Attachment point 106 may be a cotter pin 202 placed through the hole in disk 108. Base fastener 110 may be placed over the cotter pin 202 to rest on the disk 108 on the opposite side of disk 108 from base fastener 110. The hole in disk 108 may be sized such that only an end portion 202a of the cotter pin 202 may fit through, leaving the head 202b of the cotter pin 202 exposed to form the attachment point. As depicted in FIGS. 2A and 2B, the ends 202a of the cotter pin 202 may be split and bent outwards near base fastener 110, securing the disk 108, the base, and the base fastener, to form base 102. The cotter pin 202 may be trimmed such as to not interfere with the engagement of fasteners 110 and 112. In one embodiment, an insert such as a small washer, may be placed over the cotter pin 202 and onto the fastener 110 prior to bending the ends 202a of cotter pin 202. This insert may help to stabilize the assembled components of base 102. Additionally, an adhesive may be used either alone or in conjunction with other fastening methods to produce base 102.

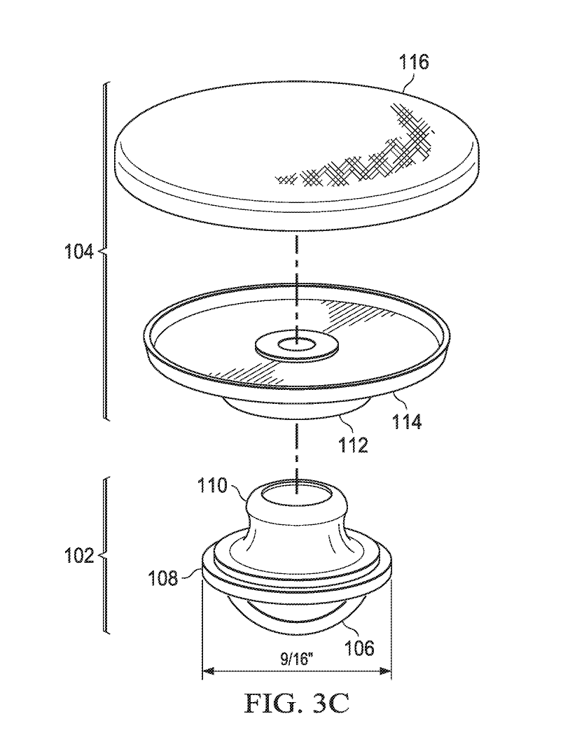

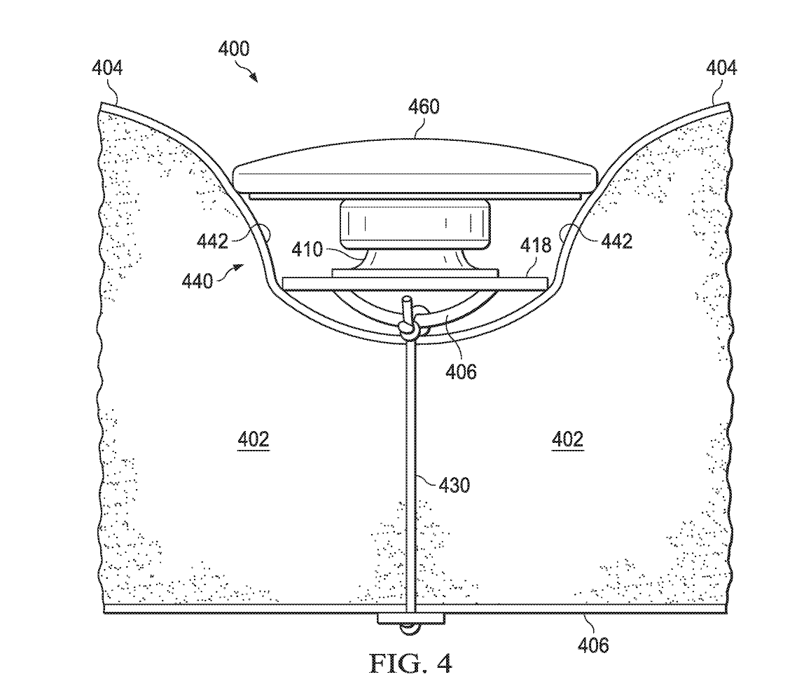

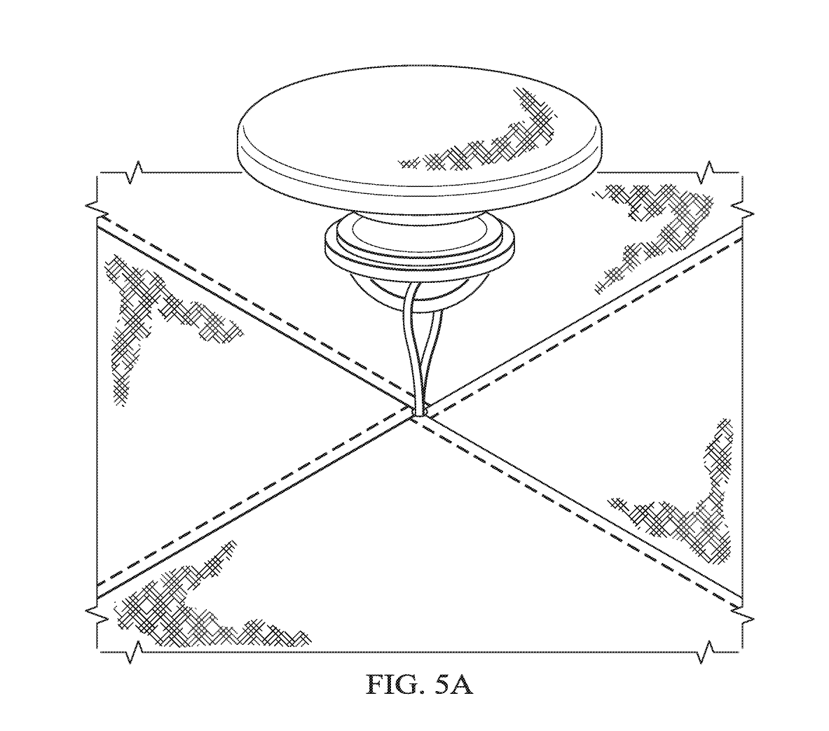

FIGS. 3A-3C depict other embodiments of an interchangeable button system where, the disk and attachment point may be formed out of a single piece of material. Turning first to FIG. 3A, an exploded view of one embodiment of a base of an interchangeable button system is depicted. Here, base 102 may include fastener 110 coupled to disk 108. Disk 108 may be a disk of metal such as stainless steel which may, for example, be ⅞″ or 9/16″ diameter by 1/32″ thick. Attachment point 106 may be formed in disk 108 by forming a half-shear in the disk 108 and punching or extruding the half-shear to form attachment point 106. The attachment point 106, in one embodiment, may be disposed approximately at the center of the disk 108 and be approximately ½″ long by 3/32″ wide by ⅛″ deep (e.g., at its highest point from surface of disk 108).

Here, to manufacturer or otherwise make base 102, a stainless steel slug of approximately the desired diameter and thickness may be stamped, pressed, or otherwise created from stainless steel (e.g., from a sheet of stainless steel). In one embodiment for example, the disk 108 is formed out of a flat sheet on a punch press. Attachment point 106 may be formed by punching or pressing the stainless steel slug. For example, a half-shear approximately ½″ long and 3/32″ wide may be made in the disk 108 approximately in the center of the disk 108. Force (e.g., extruding, pressing or punching force) may then be applied on this half-shear to cause that area of the disk 108 to extrude to form attachment point 106 of approximately ⅛″ depth. In one embodiment, the half-shear or the attachment point 106 itself may be created in the disk 108 before the disk 108 is created in the sheet of material or before the disk 108 is punched out from the sheet of material. The disk 108 may be tumbled or polished with a media such as ceramic media, walnut shells, sand or other abrasive media or material to achieve a desired texture or level of smoothness. This may alleviate abrasion by the disk 108 on the upholstery of the furniture or the thread used to attach the base 102 to the furniture.

Base fastener 110 may then be coupled to the disk 108 opposite the attachment point 106. Base fastener 110 may be coupled to the disk 108, for example by spot or tack welding or by an adhesive. For example, the fastener 100 may be spot welded to the stainless steel disk 108 opposite the attachment point 106 in four places with a jig that holds the fastener 110 approximately centered on the disk 108. The base fastener 110 may be, for example, a standard marine stainless steel snap approximately 9/16″ in diameter by 3/16″ tall.

FIG. 3B is a view of one embodiment of an interchangeable button system with a base as depicted in FIG. 3A utilizing a size #60 button cap having a diameter of approximately 1 and 15/32″. This may be a standard size metal cap (e.g., size #60) configured to accept a fabric cover. The disk 108 in this embodiment may be approximately ⅞″ in diameter and a thickness of approximately 1/32″. Attachment point 106 is disposed approximately at the center of the disk 108 and is approximately ½″ long by 3/32″ wide by ⅛″ deep.

FIG. 3C is a view of one embodiment of an interchangeable button system with a base as depicted in FIG. 3A utilizing a size #45 button cap having a diameter of approximately 1″ and 3/32″. This may be a standard size metal cap (e.g., size #45) configured to accept a fabric cover. The disk 108 in this embodiment may be approximately 9/16″ in diameter and a thickness of approximately 1/32″. Other embodiments for use with a size #45 button may have a disk 108 of approximately ⅝″ in diameter. Attachment point 106 is disposed approximately at the center of the disk 108 and is approximately ½″ long by 3/32″ wide by ⅛″ deep.

Button 104 may be comprised of button base 114, button cap 116, and button fastener 112. Button fastener 112 may be attached to button base 114 (e.g., such as by welding or adhesive), or may be formed integrally with button base 114 or button cap 116. In one embodiment, button fastener 112 may comprise a half of a snap fastener, with base fastener 110 and button fastener 112 being mating halves of a snap fastener. Button base 114 and button cap 116 may be attached together to form button 104. Button 104 may also be comprised of any number of components fixed together or may be a single piece. In one embodiment, fabric may be placed over button cap 116 to cover button cap. Button cap 116 may then be attached to button base 114, such as by crimping, thereby securing the fabric to the button. Other materials may be placed over button cap 116, such as leather, vinyl, etc. In some embodiments, button cap 116 may be not be covered by a material. Button base 114 and button cap 116 may be a single piece and may be comprised of one or more materials, including metal, wood, ceramic, polymer, glass, etc.

In use, base 102 may be attached to a piece of furniture via attachment point 106 using any means known in the art, such as by thread. Base fastener 110 and button fastener 112 may fasten together, securing button 104 to base 102. In this way, both base 102 and button 104 may be secured to a piece of furniture. A user wishing to replace button 104 disengages button fastener 112 from base fastener 110 and removes button 104. The user then engages button fastener of the new button with base fastener 110.

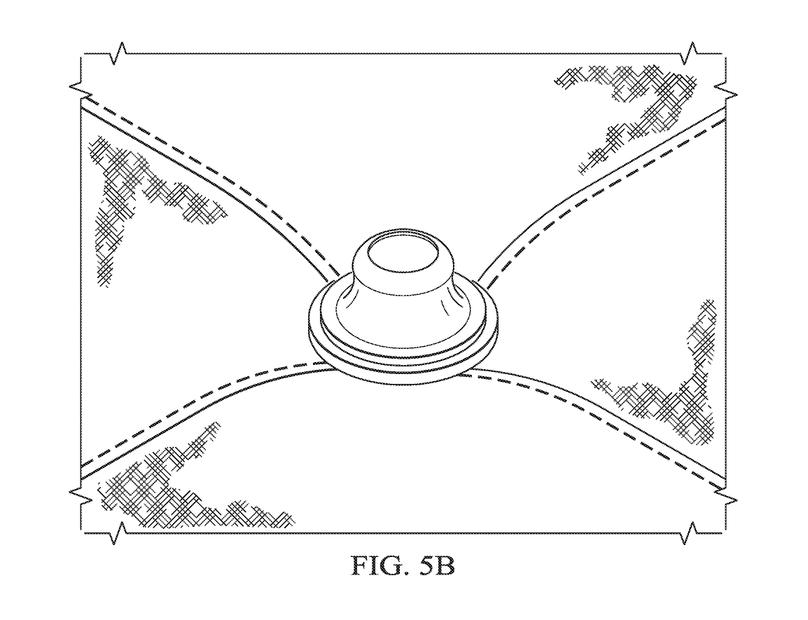

FIG. 4 depicts a cross sectional view of the use of an embodiment of an interchangeable button system used to create and maintain a tuft in the upholstery of a piece of furniture. Furniture 400 includes a stuffing material 402 covered by upholstery 404. The bottom 406 of the furniture 400 may include a decking or webbing opposite the upholstery 404. Base 410 of interchangeable button system 420 may be attached to furniture 400 using thread, wire or other attachment mechanism 430. In particular, thread or wire 430 is passed through attachment point 416 of base 410 and force is applied to the thread in a direction toward bottom 406 of furniture 400, in turn causing the disk 418 of the base 410 to exert force on the upholstery 404 and form tuft 440. When tuft 440 is at a desired depth the thread or wire 430 may be tied off or otherwise secured against the bottom 406 of the furniture 404. Button 460 is secured to the base 410 using their respective fasteners. As can be seen, the tufting force (e.g., the force applied to the upholstery 404 to create and maintain tuft 440) is applied through the disk 418 of the interchangeable button system, not through button 460. Moreover, the disk 418 through which the tufting force is applied is of a diameter selected (e.g., relative to the diameter of the button) such that the walls 442 of tuft 440 do not apply removing force to button 460 in normal use of the furniture 404, such as, for example, when a person seats themselves, shifts upon, or rises from, furniture 404.

When an owner or other person wishes to change the button 460 however, the button 460 may easily be removed from base 410 and another button fastened onto base 410 without removal of base 410 or thread 430. In this manner, an interchangeable button system such as that disclosed herein may be used to in conjunction with upholstered furniture (including tufted upholstery) to provide an easy and straightforward mechanism for replacing buttons on furniture without the need to remove or reattach anything to the furniture itself.

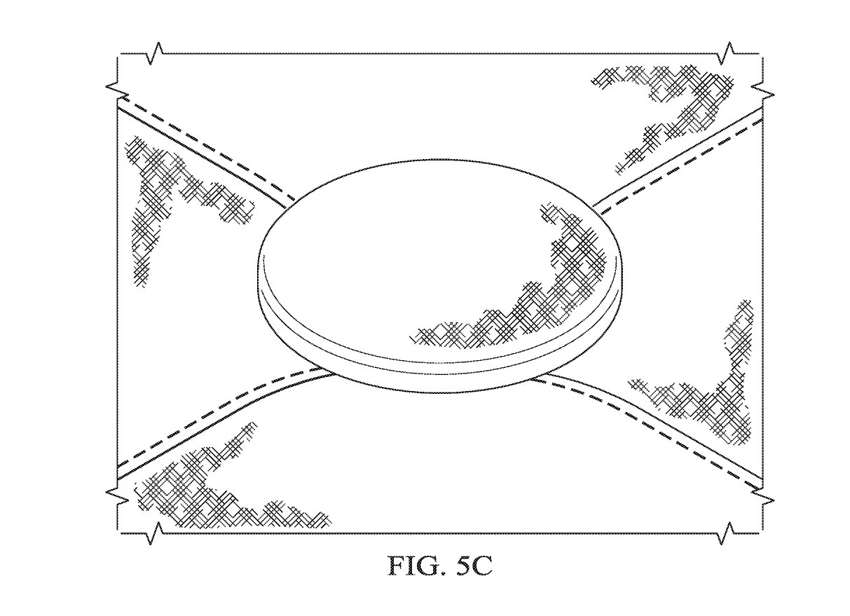

FIGS. 5A-5C illustrate one embodiment of an interchangeable button system attached to a piece of furniture. Specifically, in FIG. 5A, an interchangeable button system coupled to a piece of furniture by a piece of thread through an attachment point of a base is illustrated. In FIG. 5B, the base of an interchangeable button system used to create and maintain a tuft in the piece of furniture is depicted. FIG. 5C depicts a button attached to the base as depicted in FIG. 5B.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “e.g.,” “in one embodiment.”

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An interchangeable button system for use in upholstering furniture, comprising:
a base, comprising:
an attachment point for attaching the base to a piece of furniture; and
a first fastener opposite the loop; and
a button, comprising:
a button base;
a second fastener configured to removeably attach the button to the first fastener of the base; and
a button cap;
wherein the first fastener is configured to attach to the second fastener.

2. The system of claim 1, wherein the base further comprises a disk.

3. The system of claim 2, wherein the disk is made of a metal.

4. The system of claim 2, wherein the disk is made of a polymer.

5. The system of claim 1, wherein the attachment point is coupled to a first side of the disk and the fastener is coupled to a second side of the disk portion.

6. The system of claim 1, wherein the fastener is a snap.

7. The system of claim 1, wherein the fastener is a magnetic fastener.

8. The system of claim 1, wherein the fastener is a threaded fastener.

9. The system of claim 1, wherein the fastener is a hook and loop fastener.

10. The system of claim 1, wherein the disk is sized to create a tuft in upholstery of the piece of furniture.

11. The system of claim 10, wherein the disk is sized such that a removing force is not applied to the button when the furniture is in use.
